(19) United States
(12) Patent Application Publication
(10) Pub. No.: US 2015/0062318 A1
(43) Pub. Date: Mar. 5, 2015

(54) DELIVERY TRANSACTION WITH CAPTURED SENTIMENT MESSAGE FROM RECIPIENT OF DELIVERED ARTICLE AND/OR SERVICE

(71) Applicant: Paul A. Wexler, Austin, TX (US)

(72) Inventor: Paul A. Wexler, Austin, TX (US)

(21) Appl. No.: 14/011,555

(22) Filed: Aug. 27, 2013

(51) Int. Cl. H04N 7/18

(52) U.S. Cl. CPC H04N 7/18
USPC 348/77

(57) ABSTRACT

A method of using a mobile data processing system for verifying a recipient of a delivered article comprises accessing a data structure of the mobile data processing system for determining if a particular delivery record specifies that a sender of an article has requested receipt of a sentiment of an intended recipient of the article resulting from receipt of the article, displaying a sentiment capture consent message on a visual display of the mobile data processing system after determining that the particular delivery record specifies that the sender of the article has requested receipt of the sentiment, and capturing the sentiment of the intended recipient of the article using a camera of the mobile data processing system in response to a recorded sentiment acceptance response being received at a sentiment capture acceptance user input interface portion of the mobile data processing system.

### FIELD OF THE DISCLOSURE

The disclosures made herein relate generally to delivery transaction solutions and, more particularly, to implementing a delivery transaction with captured sentiment message from an intended recipient of a delivered article and/or service.

### BACKGROUND

System-implemented solutions for facilitating delivery of articles are well known. These solutions generally include a device upon which a recipient of an article inputs written verification information such as their name and/or signature. In some instances, the device includes an integral video capture apparatus used for capturing a video image (or still image) of the person as they input their written verification information.

These known system-implemented solutions for facilitating delivery of an article are devised for verifying that a recipient has received an article. In many instances, the recipient that provides delivery verification information (e.g., name, signature, etc) is simply an individual at a specified delivery address for the package who is the first to greet a deliverer of the article (e.g., the person who answers a door to greet the deliverer, who sits at a reception desk, etc) as opposed to a specific individual to whom the article has been sent at the specified delivery address. As such, captured visual delivery verification information (e.g., video or still images) and associated written deliver verification will in many instances not be for a specific individual at that address to whom the article has been sent, which is not an unacceptable delivery verification outcome in that a key objective of known system-implemented solutions for facilitating delivery of articles is simply to confirm that the article has been received by a person at the specified delivery address.

The above-mentioned delivery verification solutions are well suited for an article in an unopened package. However, in many instances, an article being delivered is unpackaged or in a package intended to be opened upon delivery. Furthermore, in many instances, delivery of these types of articles is met with an expression of happiness, joy, surprise, etc. when the article (or service) is presented to an intended recipient upon delivery. For example, delivery of flowers, confections, singing telegram and/or the like from a loved-one typically evokes an expression of happiness, joy and/or surprise from the intended recipient. Therefore, a system-implemented solution for implementing a delivery transaction with captured sentiment message from an intended recipient of a delivered article and/or service would be advantageous, desirable and useful.

### SUMMARY OF THE DISCLOSURE

Embodiments of the present invention are directed to a system-implemented solution (e.g., via a smart phone) for implementing a delivery transaction with captured sentiment message from an intended recipient of a delivered article and/or service. More specifically, embodiments of the present invention are intended for situations in which a delivery (e.g., flowers, confections, a singing telegram and/or the like) is met with an expression of happiness, joy, surprise, etc. when the article (or service) is presented to an intended recipient upon delivery. Uniquely, embodiments of the present invention are specifically configured for capturing a video clip of this expression of happiness, joy, surprise, etc (i.e., their sentiment) from the intended recipient when the article and/or service is delivered to them. This sentiment of the intended recipient can then be transmitted for reception to a sender of the article.

In one embodiment of the present invention, a non-transitory computer-readable medium has tangibly embodied thereon and accessible therefrom instructions interpretable by at least one data processing device of a mobile data processing system. The instructions are configured for causing the at least one data processing device to perform one or more operations. The at least one data processing device performs an operation for displaying a visual image capture consent message on a visual display of the mobile data processing system after determining that the mobile data processing system is within a defined proximity to the delivery location specified in a particular delivery record of a data storage structure and after determining that the particular delivery record specifies that a sender of the article has requested receipt of a visual image of a recipient of the article in possession of the article. The at least one data processing device performs an operation for enabling a camera of the mobile data processing system to be used for capturing the visual image of the recipient of the article in response to a visual image capture acceptance response being received at a visual image capture acceptance user input interface portion of the mobile data processing system. The at least one data processing device performs an operation for causing a file containing the visual image to be transmitted from the mobile data processing system for reception by a remote data repository information account assigned to the sender of the article after the visual image is captured using the camera of the mobile data processing system.

In another embodiment of the present invention, a non-transitory computer-readable medium has tangibly embodied thereon and accessible therefrom instructions interpretable by at least one data processing device of a mobile data processing system. The instructions are configured for causing the at least one data processing device to perform one or more operations. The at least one data processing device performs an operation for displaying a sentiment capture consent message on a visual display of the mobile data processing system. The at least one data processing device performs an operation for displaying a sentiment request message on the visual display of the mobile data processing system in response to a recorded sentiment acceptance response being received at a sentiment capture acceptance user input interface portion of the mobile data processing system. The sentiment request message conveys information indicating that an initiator of the delivery would like a recipient of the delivery to record a sentiment resulting from receiving the delivery. The at least one data processing device performs an operation for recording the sentiment using at least a camera of the mobile data processing system after displaying the sentiment request message. The at least one data processing device performs an operation for causing a file containing the sentiment to be transmitted from the mobile data processing system for reception by a remote data repository information account assigned to the sender of the delivery after the visual image is recorded.

In another embodiment of the present invention, a method of using a mobile data processing system for verifying a recipient of a delivered article comprising a plurality of operations. An operation is performed for accessing a data structure of the mobile data processing system for determining if a particular delivery record specifies that a sender of an article has requested receipt of a sentiment of an intended recipient of the article resulting from receipt of the article. An operation is performed for displaying a sentiment capture consent message on a visual display of the mobile data processing system after determining that the particular delivery record specifies that the sender of the article has requested receipt of the sentiment. An operation is performed for capturing the sentiment of the intended recipient of the article using a camera of the mobile data processing system in response to a recorded sentiment acceptance response being received at a sentiment capture acceptance user input interface portion of the mobile data processing system.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is flow diagram showing a system-implemented method for verifying a recipient of a delivery in accordance with an embodiment of the present invention.

FIG. 2 is an embodiment of a smart phone having a delivery record page configured in accordance with an embodiment of the present invention.

FIG. 3 is an embodiment of a smart phone having a delivery navigation page configured in accordance with an embodiment of the present invention.

FIG. 4 is an embodiment of a smart phone having a sentiment capture consent page configured in accordance with an embodiment of the present invention.

FIG. 5 is an embodiment of a smart phone having a sentiment record page configured in accordance with an embodiment of the present invention.

FIG. 6 is an embodiment of a smart phone having a recorded sentiment acceptance page configured in accordance with an embodiment of the present invention.

FIG. 7 is an embodiment of a smart phone having a sentiment access page configured in accordance with an embodiment of the present invention.

FIG. 8 is an embodiment of a smart phone having a delivery status page configured in accordance with an embodiment of the present invention.

FIG. 9 shows a diagrammatic representation of an embodiment of a computer system configured in accordance with an embodiment of the present invention.

### DETAILED DESCRIPTION

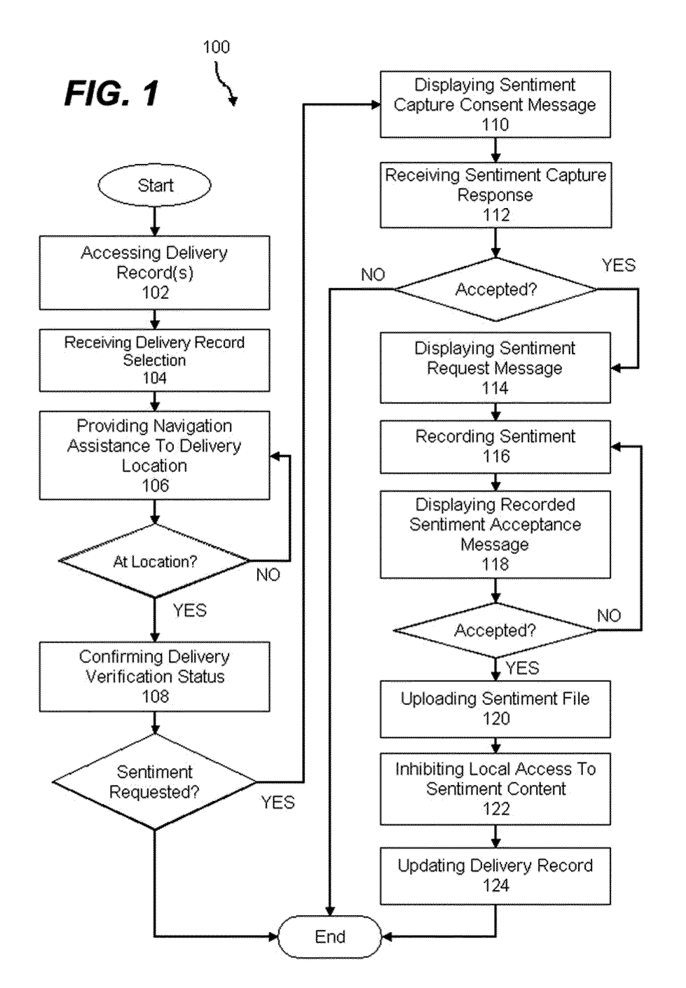

FIG. 1 is a flow diagram showing an embodiment of a system-implemented method (i.e., method 100) data processing system for verifying a recipient of a delivery. It is disclosed herein that the delivery can be that of an article (e.g., gift basket, flowers, etc) and/or a service (e.g., a singing telegram) to an intended recipient (e.g., a person or organization). Embodiments of the present invention are not limited to any particular type of delivery. Furthermore, although the method steps described herein are discussed in a particular order, one of skill in the art will recognize that many method steps can be carried out in a different order and overlap in time without departing from the spirit of this disclosure.

The method 100 of FIG. 1 implements a delivery transaction with a captured sentiment message from an intended recipient of a delivered article and/or service. In this regard, embodiments of the present invention are uniquely configured for capturing a video clip of this expression of happiness, joy, surprise, etc (i.e., their sentiment) from the intended recipient when the article and/or service is delivered to them. This sentiment can be captured via a visual image clip, an audio clip or a combination thereof. Examples of a delivery in the context of the present invention include, but are not limited to, flowers, confections, a singing telegram and/or the like.

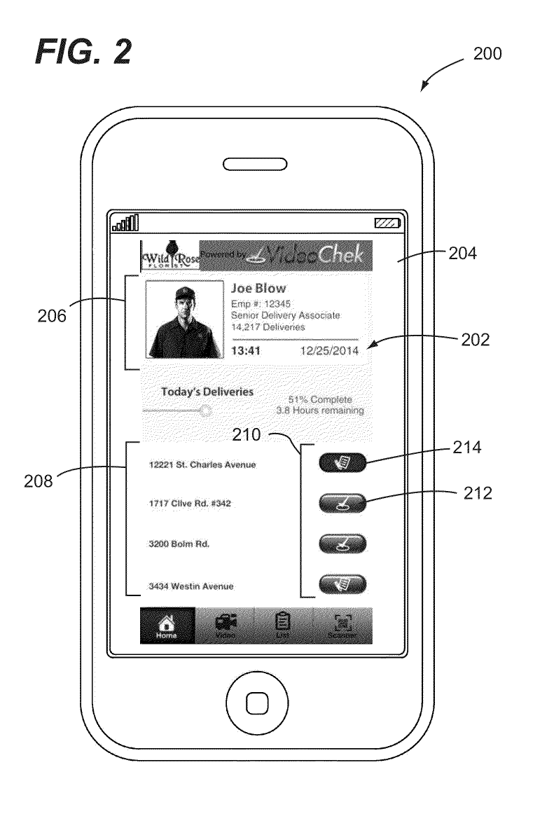

The method 100 is preferably implemented via a mobile data processing system such as, for example, the smart phone 200 shown in FIGS. 2-8. A smart phone and similarly capable types of tablets and notepads are each an example of a mobile data processing system in the context of embodiments of the present invention. An Apple iPhone brand cellular telephone and a cellular phone with an Android brand operating system are examples of smart phones. It is disclosed herein that embodiments of the present invention are not limited to any particular brand, form or configuration of mobile data processing system.

The method 100 begins with an operation 102 for accessing delivery records corresponding to articles and/or services that are to be delivered to an intended recipient. As shown in FIG. 2, delivery records can be visualized through display of a delivery record page 202 on a visual display 204 of the smart phone 200 (i.e., an instance of thereof that is at the delivery location (e.g., a smart phone in possession of the delivery personnel)). The delivery record page 202 can include delivery personnel information 206, one or more delivery record identifiers 208 (i.e., uniquely identified by a street address), and delivery verification type information 210 (e.g., verification via captured visual image (e.g., icon 212), verification via signature (e.g., icon 214), etc). It is disclosed herein that the delivery records can be accessed from a local data structure such as in local memory of the smart phone 200 and/or from a remote data structure such as in remote memory or storage in a cloud computing system.

After accessing the delivery records, an operation 104 is performed for receiving a delivery record selection of a particular delivery record. One example of selecting the particular delivery record includes touching on an area of the visual display 204 (i.e., user input interface portion) above a particular one of the delivery record identifiers 208 thereby causing the delivery record corresponding to the particular one of the delivery record identifiers 208 to be selected.

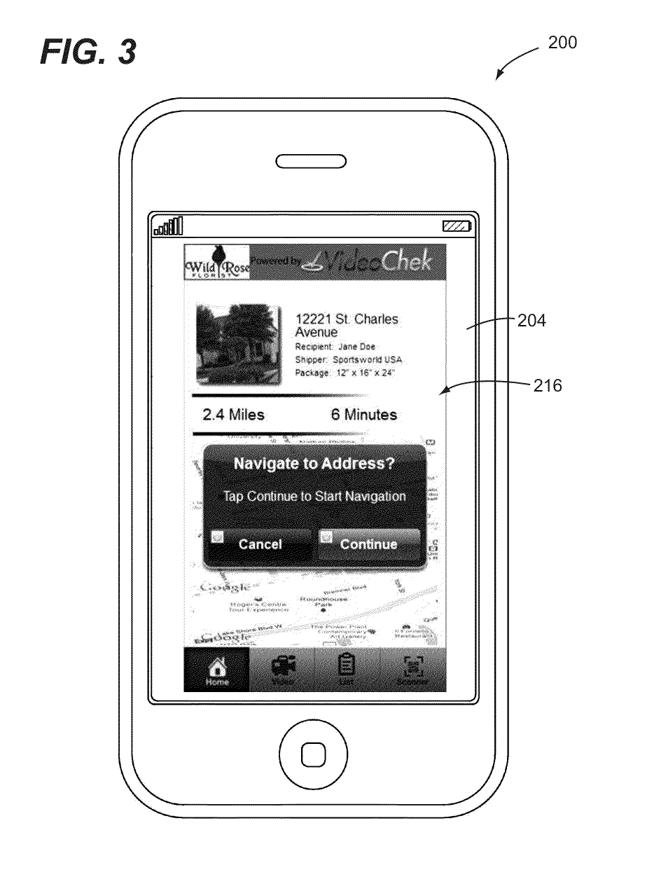

In response to the operation 104 being performed for receiving a delivery record selection of a particular delivery record, an operation 106 is performed for providing navigation assistance to a delivery location (e.g., street address) specified in the particular delivery record. As shown in FIG. 3, navigation assistance can be provided through a delivery navigation page 216 on the visual display 204 of the smart phone 200. Providing navigation assistance can entail using navigation functionality of the smart phone 200 to approximate a position of the smart phone 200 to the delivery location specified in the particular delivery record thereby determining if the smart phone 200 is within a defined proximity to the delivery location. Various forms of navigation solutions for smart phones and other similar types of mobile data processing system are well known (e.g., those available for use on an Apple iPhone brand cellular telephone and/or a cellular phone with an Android brand operating system).

When it is determined that the smart phone is within the defined proximity to the delivery location (e.g., within a system specified distance), an operation 108 is performed for confirming a delivery verification status as specified in the particular delivery record. Examples of the delivery verification status include, but are not limited to, verification via captured visual image (e.g., icon 212 in FIG. 2), verification via signature (e.g., icon 214 in FIG. 2) and the like. It is disclosed herein that confirmation of the delivery verification status can entail an initial accessing and assessing of such information from a local or remote source or can entail assessing such information that was previously downloaded from a remote source (e.g., downloading of the delivery record and all information associated therewith from a cloud computing system in response to selection of the particular delivery record).

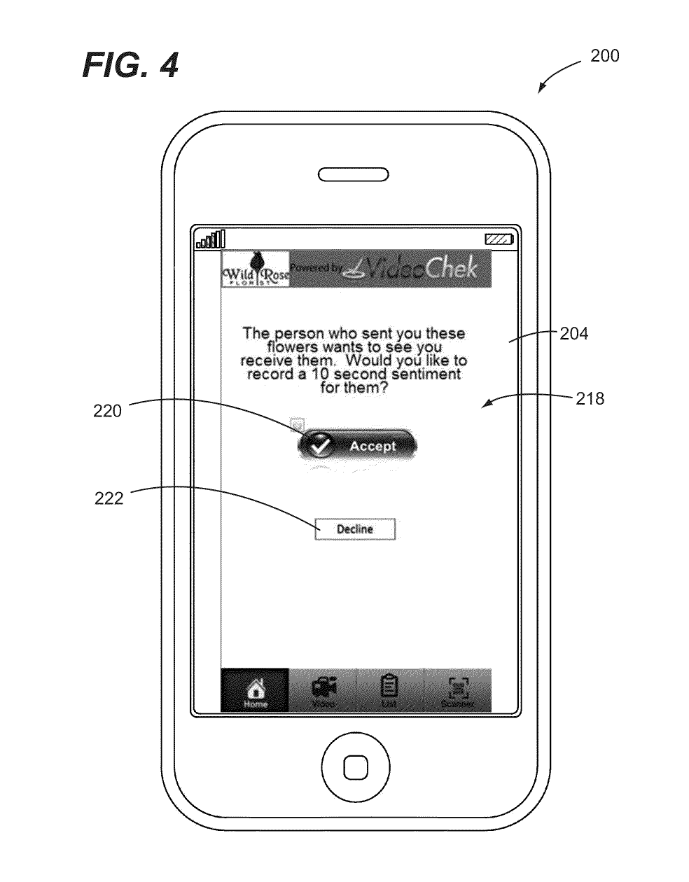

If it is determined that a sentiment resulting from the delivery has been requested from the recipient, an operation 110 is performed for displaying a sentiment capture consent message. As shown in FIG. 4, the sentiment capture consent message can be provided through a sentiment capture consent page 218 on the visual display 204 of the smart phone 200. The sentiment capture consent message conveys that the person or organization (i.e., entity) that has initiated the delivery has requested the recipient of the delivery to provide the initiator with a recording (e.g., visual image and, optionally, corresponding audio) of their sentiment resulting from receipt of the delivery. Otherwise, if it is determined that a sentiment resulting from the delivery has not been requested from the recipient, the method 100 ends.

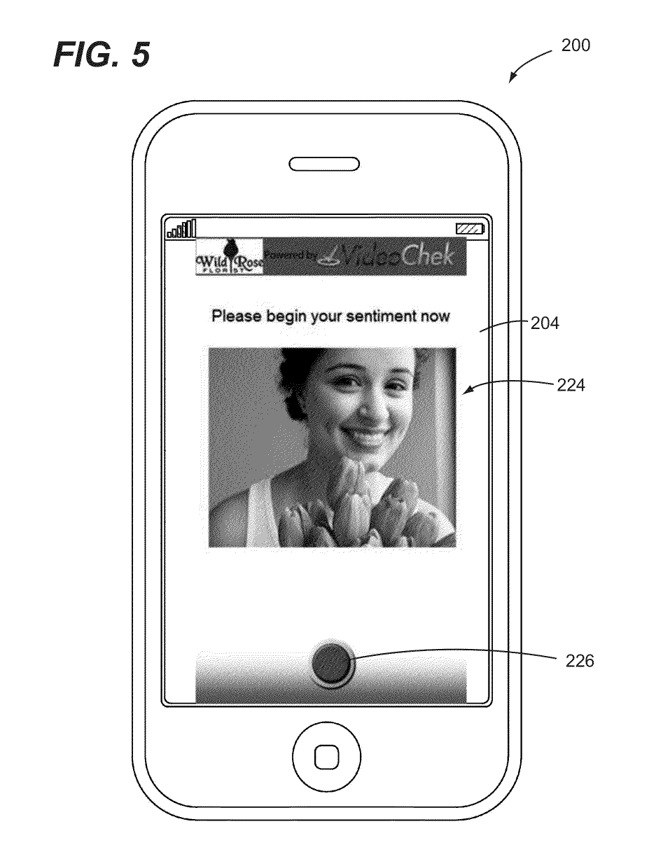

After the sentiment capture consent message is displayed, an operation 112 is performed for receiving a sentiment capture response. For example, the sentiment capture consent page 218 shown in FIG. 4 includes a selection for accepting the request for a recorded sentiment (e.g., button 220) and a selection for declining the request for a recorded sentiment (e.g., button 222). If the sentiment capture response corresponds to the selection for accepting the request for the recorded sentiment (e.g., selection of the button 220), an operation 114 is performed for displaying a sentiment record message. For example, a sentiment record page 224 as shown in FIG. 5 can be displayed on the visual display 204 of the smart phone 200 and can include a record control button 226 for allowing recording of the sentiment to be selectively started and stopped. Otherwise, if the sentiment capture response corresponds to the selection for declining the request for the recorded sentiment (e.g., selection of the button 222), the methods 100 can end without further action or can display a page requesting signature delivery verification from the recipient (e.g., a field for signature by the recipient and corresponding text specifying terms and conditions of delivery).

Display of the sentiment record message enables an operation 116 to be performed for recording the sentiment. For example, input devices of the smart phone 200 (e.g., camera and microphone) can be used for recording the sentiment and, through selection of the record control button 226, recording can be selectively started and stopped. It is disclosed herein that a maximum duration of time for the sentiment (e.g., 10 seconds) can be implemented for limiting a length of the sentiment. For example, the maximum duration of time for the sentiment can result in recording of the sentiment to automatically stopping once the maximum duration of time for the sentiment has elapsed from a time the record control button 226 has been depressed for starting recording of the sentiment.

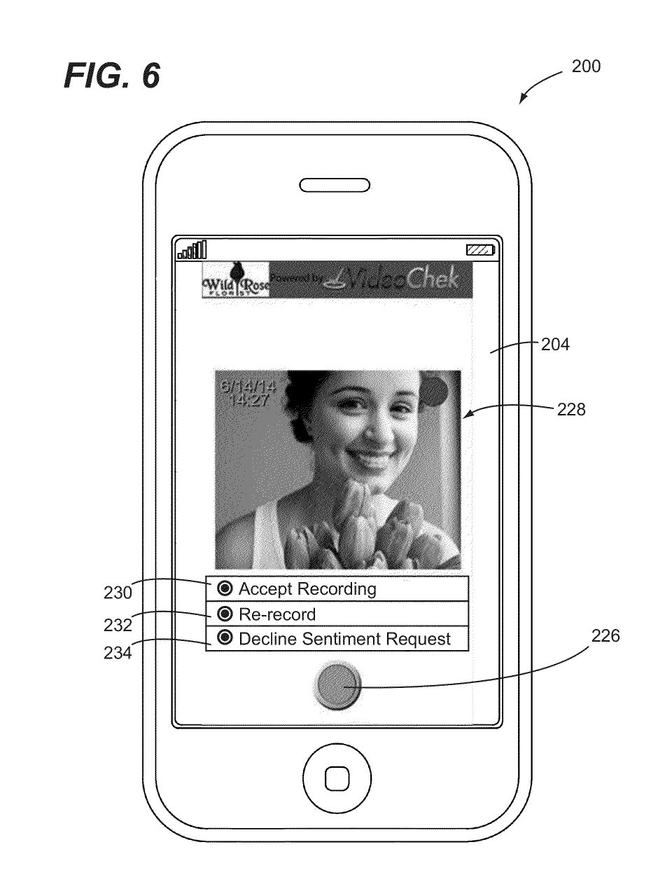

Upon termination of a current instance of a sentiment record operation (e.g., the record control button 226 being depressed for stopping recording of the sentiment), an operation 118 is performed for displaying a recorded sentiment acceptance message. As shown in FIG. 6, the recorded sentiment acceptance message can be provided through a recorded sentiment acceptance page 228 on the visual display 204 of the smart phone 200. The recorded sentiment acceptance page 228 provides displayed content for allowing the recipient to accept a currently recorded version of the sentiment (e.g., recorded sentiment acceptance button 230) and provides displayed content for allowing the recipient to re-record the sentiment (e.g., sentiment re-record button 232). Alternatively, the recorded sentiment acceptance page 228 can provides displayed content for allowing the recipient to decline further their previously consent to the request for the recorded sentiment (e.g., sentiment consent decline button 234) that can be selected, for example, after one or more failed attempts at recording the sentiment.

If the recorded sentiment is accepted (e.g., through selection of the recorded sentiment acceptance button 230), an operation 120 is performed for causing a file containing the currently recorded sentiment (i.e., the recorded sentiment file) to be uploaded to a remote data repository information account assigned to the initiating entity of the delivery (e.g., the sender of an article). Examples of the remote data repository include, but are not limited to a data repository of a social network server on which the initiating entity has an account, a data repository of a cloud server on which the initiating entity has an account, an email server on which the initiating entity has an account, etc. Embodiments of the present invention are not limited to any particular type and/or location of remote data repository. Such uploading can take place through a network to which the smart phone 200 is connected.

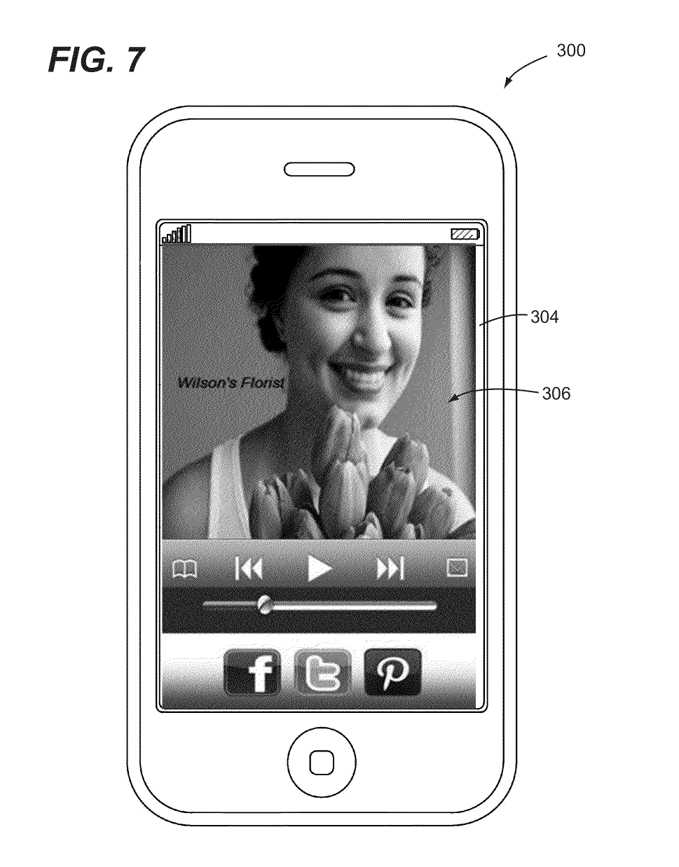

As shown in FIG. 7, the recorded sentiment file can be played back and/or shared via a sentiment access page 306 displayed on a visual display 304 of a smart phone 300 of the initiator of the delivery. Through the sentiment access page 306, the initiator of the delivery can access and playback the recorded sentiment file and can share the recorded sentiment file by means such as, for example, an sms account, an email account, a Facebook account, a Twitter account, an Instagram account, a Google account and/or a Pinterest account. Such access and/or sharing can take place through a network to which the smart phone 300 is connected. Accordingly, the sentiment access page 306 will only be available to the initiator of the delivery (i.e., the person or organization that placed the order and requested the sentiment/delivery verification).

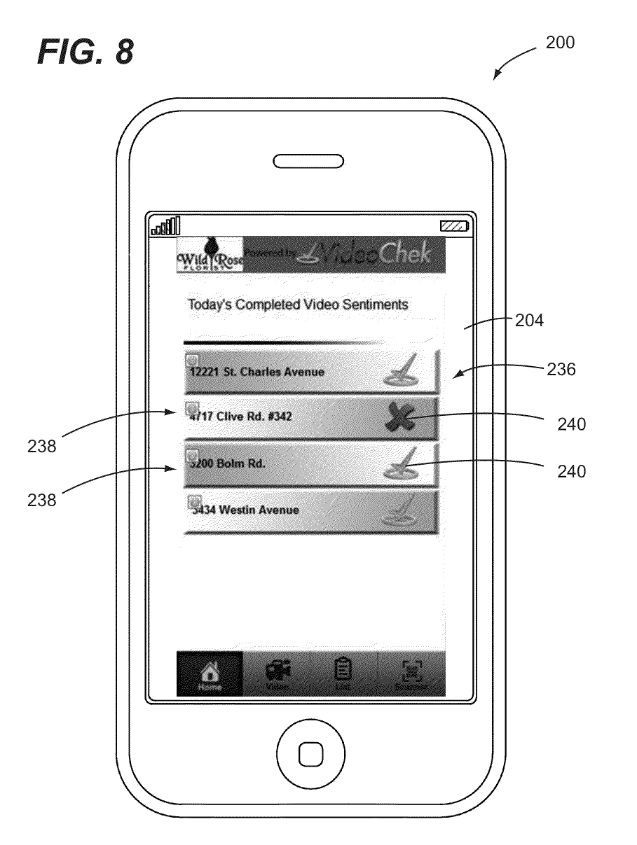

In conjunction with the recorded sentiment file being uploaded, an operation 122 is performed for inhibiting local access to the recorded sentiment file (i.e., recorded sentiment content) and an operation 124 is performed for updating the particular delivery record to reflect the current status of the delivery verification. For example, inhibiting local access to the recorded sentiment file can include inhibiting any and all sentiment content resulting from one or more actions following reception of the recorded sentiment acceptance response from being copied, replayed, shared and/or edited without authorization of the initiator of the delivery after causing the file containing the currently recorded version of the sentiment to be successfully uploaded to the remote data repository information account assigned to the initiator of the delivery Accordingly, the sentiment access page 306 cannot be accessed by the recipient or the delivery personnel without authorization of the initiator of the delivery (i.e., providing remote data repository account access information thereto). Referring back to the smart phone 200 of the delivery personnel, FIG. 8 shows a delivery status page 236 showing one or more delivery record identifiers 238 (i.e., uniquely identified by a street address) and a corresponding delivery verification status identifier 240. The delivery verification status identifier 240 indicates if the sentiment request was accepted and successfully fulfilled (e.g., a first icon in the form of a check mark) or if the sentiment request was declined or otherwise unsuccessful (e.g., a second icon in the form of a “X”).

It is disclosed herein that the method 100 of FIG. 1 can be implemented via a mobile data processing system of a delivery personnel. It is also disclosed herein that the method 100 of FIG. 1 can be implemented via a data processing system (e.g., a mobile data processing system) of an intended recipient of a delivered article and/or service. For example, a delivery management system (e.g., server that shares information with the mobile data processing system of the delivery personnel) can be configured to indicate when an article or service has been delivered and to send a sentiment capture request message to a data processing system of the intended recipient. Operations 110-120 of the method 100 are then performed via the data processing system of the intended recipient. Information for providing the sentiment capture request message to the data processing system of the intended recipient can be provided to the delivery management system. The file containing the recorded sentiment can be sent from the data processing system of the intended recipient to a remote data repository information account assigned to the initiating entity of the delivery (e.g., the sender of an article) without involvement of the delivery management system.

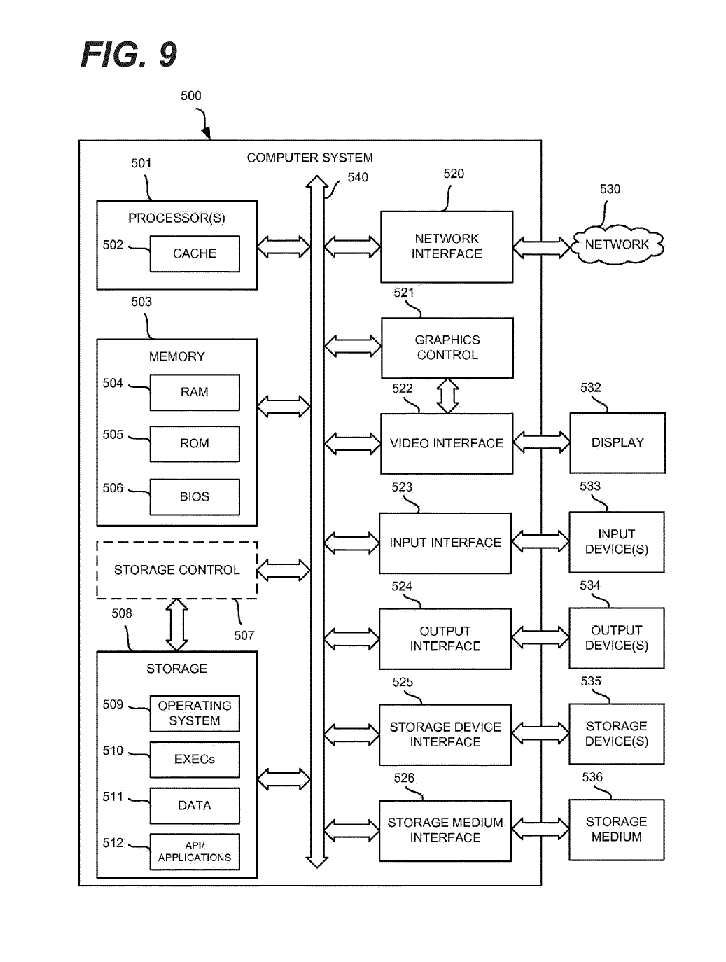

Turning now to a discussion of approaches for implementing embodiments of the present invention, systems and methods in accordance with embodiments of the present invention can be implemented in any number of different types of data processing systems (e.g., a computer system) in addition to the specific physical implementation of a data processing system in the form of a smart phone. To this end, FIG. 5 shows a diagrammatic representation of one embodiment of a computer system 500 within which a set of instructions can execute for causing a device to perform or execute any one or more of the aspects and/or methodologies of the present disclosure. The components in FIG. 9 are examples only and do not limit the scope of use or functionality of any hardware, software, embedded logic component, or a combination of two or more such components implementing particular embodiments.

The Computer system 500 can include a processor 501, a memory 503, and a storage 508 that communicate with each other, and with other components, via a bus 540. The bus 540 can also link a display 532, one or more input devices 533 (which can, for example, include a keypad, a keyboard, a mouse, a stylus, etc.), one or more output devices 534, one or more storage devices 535, and various tangible storage media 536. All of these elements can interface directly or via one or more interfaces or adaptors to the bus 540. For instance, the various tangible storage media 536 can interface with the bus 540 via storage medium interface 526. Computer system 500 can have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers. All or a portion of the elements 501-536 can be housed in a single unit (e.g., a cell phone housing, a tablet housing, or the like).

Processor(s) 501 (or central processing unit(s) (CPU(s))) optionally contains a cache memory unit 502 for temporary local storage of instructions, data, or computer addresses. Processor(s) 501 are configured to assist in execution of computer readable instructions. Computer system 500 can provide functionality as a result of the processor(s) 501 executing software embodied in one or more tangible computer-readable storage media, such as memory 503, storage 508, storage devices 535, and/or storage medium 536. The computer-readable media can store software that implements particular embodiments, and processor(s) 501 can execute the software. Memory 503 can read the software from one or more other computer-readable media (such as mass storage device(s) 535, 536) or from one or more other sources through a suitable interface, such as network interface 520. The software can cause processor(s) 501 to carry out one or more processes or one or more steps of one or more processes described or illustrated herein. Carrying out such processes or steps can include defining data structures stored in memory 503 and modifying the data structures as directed by the software.

The memory 503 can include various components (e.g., machine readable media) including, but not limited to, a random access memory component (e.g., RAM 504) (e.g., a static RAM “SRAM”, a dynamic RAM “DRAM, etc.), a read-only component (e.g., ROM 505), and any combinations thereof. ROM 505 can act to communicate data and instructions unidirectionally to processor(s) 501, and RAM 504 can act to communicate data and instructions bidirectionally with processor(s) 501. ROM 505 and RAM 504 can include any suitable tangible computer-readable media described below. In one example, a basic input/output system 506 (BIOS), including basic routines that help to transfer information between elements within computer system 500, such as during start-up, can be stored in the memory 503.

Fixed storage 508 is connected bidirectionally to processor(s) 501, optionally through storage control unit 507. Fixed storage 508 provides additional data storage capacity and can also include any suitable tangible computer-readable media described herein. Storage 508 can be used to store operating system 509, EXECs 510 (executables), data 511, APV applications 512 (application programs), and the like. Often, although not always, storage 508 is a secondary storage medium (such as a hard disk) that is slower than primary storage (e.g., memory 503). Storage 508 can also include an optical disk drive, a solid-state memory device (e.g., flash-based systems), or a combination of any of the above. Information in storage 508 can, in appropriate cases, be incorporated as virtual memory in memory 503.

In one example, storage device(s) 535 can be removably interfaced with computer system 500 (e.g., via an external port connector (not shown)) via a storage device interface 525. Particularly, storage device(s) 535 and an associated machine-readable medium can provide nonvolatile and/or volatile storage of machine-readable instructions, data structures, program modules, and/or other data for the computer system 500. In one example, software can reside, completely or partially, within a machine-readable medium on storage device(s) 535. In another example, software can reside, completely or partially, within processor(s) 501.

Bus 540 connects a wide variety of subsystems. Herein, reference to a bus can encompass one or more digital signal lines serving a common function, where appropriate. Bus 540 can be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof

Computer system 500 can also include an input device 533. In one example, a user of computer system 500 can enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 533 can be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 can communicate with other devices, specifically mobile devices and enterprise systems, connected to network 530. Communications to and from computer system 500 can be sent through network interface 520. For example, network interface 520 can receive incoming communications (such as requests or responses from other devices) in the form of one or more packets (such as Internet Protocol (IP) packets) from network 530, and computer system 500 can store the incoming communications in memory 503 for processing. Computer system 500 can similarly store outgoing communications (such as requests or responses to other devices) in the form of one or more packets in memory 503 and communicated to network 530 from network interface 520. Processor(s) 501 can access these communication packets stored in memory 503 for processing.

Examples of the network interface 520 include, but are not limited to, a network interface card, a modem, and any combination thereof. Examples of a network 530 or network segment 530 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 530, can employ a wired and/or a wireless mode of communication. In general, any network topology can be used.

Information and data can be displayed through a display 532. Examples of a display 532 include, but are not limited to, a liquid crystal display (LCD), an organic liquid crystal display (OLED), a cathode ray tube (CRT), a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521.

In addition to a display 532, computer system 500 can include one or more other peripheral output devices 534 including, but not limited to, an audio speaker, a printer, and any combinations thereof. Such peripheral output devices can be connected to the bus 540 via an output interface 524. Examples of an output interface 524 include, but are not limited to, a serial port, a parallel connection, a USB port, a FIREWIRE port, a THUNDERBOLT port, and any combinations thereof

In addition or as an alternative, computer system 500 can provide functionality as a result of logic hardwired or otherwise embodied in a circuit, which can operate in place of or together with software to execute one or more processes or one or more steps of one or more processes described or illustrated herein. Reference to software in this disclosure can encompass logic, and reference to logic can encompass software. Moreover, reference to a computer-readable medium (also sometimes referred to as machine-readable medium” can encompass a circuit (such as an IC) storing software for execution, a circuit embodying logic for execution, or both, where appropriate. The present disclosure encompasses any suitable combination of hardware, software, or both.

The term “computer-readable medium” should be understood to include any structure that participates in providing data that can be read by an element of a computer system. Such a medium can take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

Those of skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present invention.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

The previous description of the disclosed embodiments is provided to enable any person skilled in the art to make or use the present invention. Various modifications to these embodiments will be readily apparent to those skilled in the art, and the generic principles defined herein can be applied to other embodiments without departing from the spirit or scope of the invention. Thus, the present invention is not intended to be limited to the embodiments shown herein but is to be accorded the widest scope consistent with the principles and novel features disclosed herein.

Although the present invention has been described with reference to several exemplary embodiments, it is understood that the words that have been used are words of description and illustration, rather than words of limitation. Changes can be made within the purview of the appended claims, as presently stated and as amended, without departing from the scope and spirit of the present invention in all its aspects. Although the present invention has been described with reference to particular means, materials and embodiments, the present invention is not intended to be limited to the particulars disclosed; rather, the present invention extends to all functionally equivalent technologies, structures, methods and uses such as are within the scope of the appended claims.

What is claimed is:

1. A non-transitory computer-readable medium having tangibly embodied thereon and accessible therefrom instructions interpretable by at least one data processing device of a mobile data processing system, the instructions are configured for causing the at least one data processing device to perform one or more operations for:
displaying a visual image capture consent message on a visual display of the mobile data processing system after determining that the mobile data processing system is within a defined proximity to the delivery location specified in a particular delivery record of a data storage structure and after determining that the particular delivery record specifies that a sender of the article has requested receipt of a visual image of a recipient of the article in possession of the article;
enabling a camera of the mobile data processing system to be used for capturing the visual image of the recipient of the article in response to a visual image capture acceptance response being received at a visual image capture acceptance user input interface portion of the mobile data processing system; and
causing a file containing the visual image to be transmitted from the mobile data processing system for reception by a remote data repository information account assigned to the sender of the article after the visual image is captured using the camera of the mobile data processing system.

2. The non-transitory computer-readable medium of claim 1 wherein:
the instructions are further configured for causing the at least one data processing device to perform one or more operations for using navigation functionality of the mobile data processing system to approximate a position of the mobile data processing system relative to a delivery location specified in the particular delivery record for determining if the mobile data processing system is within the defined proximity to the delivery location; and
displaying the visual image capture consent message is initiated in response to a determination that the mobile data processing system is within the predefined proximity to the delivery location specified in the particular delivery record.

3. The non-transitory computer-readable medium of claim 1 wherein:
the instructions are further configured for causing the at least one data processing device to perform one or more operations for displaying a sentiment request message on the visual display of the mobile data processing system in response to the visual image capture acceptance response being received at the visual image capture acceptance user input interface portion of the mobile data processing system; and
the sentiment request message conveys information indicating that the sender of the article would like the recipient to record a sentiment resulting from receiving the article.

4. The non-transitory computer-readable medium of claim 1 wherein:
the instructions are further configured for causing the at least one data processing device to perform one or more operations for displaying a recorded sentiment acceptance message on the visual display of the mobile data processing system in response to completion of the visual image of the recipient of the article being captured using the camera of the mobile data processing system; and
the recorded sentiment acceptance message conveys information indicating that the recipient provides approval for a currently recorded version of the visual image to used as confirmation of receipt of the article.

5. The non-transitory computer-readable medium of claim 4 wherein causing the file containing the visual image to be transmitted includes causing a file containing the currently recorded version of the visual image to be uploaded to the remote data repository information account assigned to the sender of the article in response to a delivery verification response being received at a delivery verification response input interface portion of the mobile data processing system.

6. The non-transitory computer-readable medium of claim 5 wherein:
the instructions are further configured for causing the at least one data processing device to perform one or more operations for using navigation functionality of the mobile data processing system to approximate a position of the mobile data processing system relative to a delivery location specified in the particular delivery record for determining if the mobile data processing system is within the defined proximity to the delivery location; and
displaying the visual image capture consent message is initiated in response to a determination that the mobile data processing system is within the predefined proximity to the delivery location specified in the particular delivery record.

7. The non-transitory computer-readable medium of claim 5 wherein:
the instructions are further configured for causing the at least one data processing device to perform one or more operations for displaying a sentiment request message on the visual display of the mobile data processing system in response to the visual image capture acceptance response being received at the visual image capture acceptance user input interface portion of the mobile data processing system; and
the sentiment request message conveys information indicating that the sender of the article would like the recipient to record a sentiment resulting from receiving the article.

8. The non-transitory computer-readable medium of claim 7 wherein:
the instructions are further configured for causing the at least one data processing device to perform one or more operations for using navigation functionality of the mobile data processing system to approximate a position of the mobile data processing system relative to a delivery location specified in the particular delivery record for determining if the mobile data processing system is within the defined proximity to the delivery location; and
displaying the visual image capture consent message is initiated in response to a determination that the mobile data processing system is within the predefined proximity to the delivery location specified in the particular delivery record.

9. The non-transitory computer-readable medium of claim 5 wherein the instructions are further configured for causing the at least one data processing device to perform one or more operations for:
inhibiting any and all visual image content resulting from one or more action following reception of the visual image capture acceptance response from being any one of copied, replayed, shared and edited without authorization of the sender of the article after causing the file containing the currently recorded version of the visual image to be uploaded to the remote data repository information account assigned to the sender of the article.

10. A non-transitory computer-readable medium having tangibly embodied thereon and accessible therefrom instructions interpretable by at least one data processing device of a mobile data processing system, the instructions are configured for causing the at least one data processing device to perform one or more operations for:
displaying a sentiment capture consent message on a visual display of the mobile data processing system;
displaying a sentiment request message on the visual display of the mobile data processing system in response to a recorded sentiment acceptance response being received at a sentiment capture acceptance user input interface portion of the mobile data processing system, wherein the sentiment request message conveys information indicating that an initiator of the delivery would like a recipient of the delivery to record a sentiment resulting from receiving the delivery;
recording the sentiment using at least a camera of the mobile data processing system after displaying the sentiment request message; and
causing a file containing the sentiment to be transmitted from the mobile data processing system for reception by a remote data repository information account assigned to the sender of the delivery after the visual image is recorded.

11. The non-transitory computer-readable medium of claim 10 wherein:
the instructions are further configured for causing the at least one data processing device to perform one or more operations for displaying a recorded sentiment acceptance message on the visual display of the mobile data processing system in response to completion of the sentiment being recorded;
the recorded sentiment acceptance message conveys information indicating that the recipient provides approval for a currently recorded version of the sentiment to used as confirmation of receipt of the delivery; and
causing the file containing the sentiment to be transmitted includes causing a file containing the currently recorded version of the sentiment to be uploaded to the remote data repository information account assigned to the initiator of the delivery in response to a delivery verification response being received at a delivery verification response input interface portion of the mobile data processing system.

12. The non-transitory computer-readable medium of claim 10 wherein:
the instructions are further configured for causing the at least one data processing device to perform one or more operations for displaying a recorded sentiment acceptance message on the visual display of the mobile data processing system in response to completion of the sentiment being recorded; and
the recorded sentiment acceptance message conveys information indicating that the recipient provides approval for a currently recorded version of the sentiment to used as confirmation of receipt of the delivery.

13. The non-transitory computer-readable medium of claim 12 wherein the instructions are further configured for causing the at least one data processing device to perform one or more operations for:
inhibiting any and all sentiment content resulting from one or more actions following reception of the recorded sentiment acceptance response from being any one of copied, replayed, shared and edited without authorization of the initiator of the delivery after causing the file containing the currently recorded version of the sentiment to be uploaded to the remote data repository information account assigned to the initiator of the delivery.

14. A method of using a mobile data processing system for verifying a recipient of a delivered article, comprising:
accessing a data structure of the mobile data processing system for determining if a particular delivery record specifies that a sender of an article has requested receipt of a sentiment of an intended recipient of the article resulting from receipt of the article;
displaying a sentiment capture consent message on a visual display of the mobile data processing system after determining that the particular delivery record specifies that the sender of the article has requested receipt of the sentiment; and
capturing the sentiment of the intended recipient of the article using a camera of the mobile data processing system in response to a recorded sentiment acceptance response being received at a sentiment capture acceptance user input interface portion of the mobile data processing system.

15. The method of claim 14, further comprising:
causing a file containing the sentiment to be transmitted from the mobile data processing system for reception by a remote data repository information account assigned to the sender of the article after the sentiment is captured.

16. The method of claim 14 wherein capturing the sentiment is performed after using navigation functionality of the mobile data processing system to determine that the mobile data processing system is within a defined proximity to a delivery location specified in the particular delivery record.

17. The method of claim 14, further comprising:
displaying a sentiment request message on the visual display of the mobile data processing system in response to the recorded sentiment acceptance response being received at the sentiment capture acceptance user input interface portion of the mobile data processing system, wherein the sentiment request message conveys information indicating that the sender of the article would like the intended recipient to record a sentiment resulting from receiving the article.

18. The method of claim 14, further comprising:
displaying a recorded sentiment acceptance message on the visual display of the mobile data processing system in response to completion of the sentiment being captured using the camera of the mobile data processing system, wherein the recorded sentiment acceptance message conveys information indicating that the intended recipient provides approval for a currently recorded version of the sentiment to used as confirmation of receipt of the article.

19. The method of claim 18, further comprising:
causing a file containing the currently recorded version of the sentiment to be uploaded to the remote data repository information account assigned to the sender of the article in response to a delivery verification response being received at a delivery verification response input interface portion of the mobile data processing system; and
inhibiting any and all sentiment content resulting from one or more action following reception of the recorded sentiment acceptance response from being any one of copied, replayed, shared and edited without authorization of the sender of the article after causing the copy of the currently recorded version of the sentiment to be uploaded to the remote data repository information account assigned to the sender of the article.

20. The method of claim 19 wherein capturing the sentiment is performed after using navigation functionality of the mobile data processing system to determine that the mobile data processing system is within a defined proximity to a delivery location specified in the particular delivery record.
